(19) United States
(12) Patent Application Publication
(10) Pub. No.: US 2010/0136499 A1
(43) Pub. Date: Jun. 3, 2010

(54) DEVICE FOR STORING AND DISPENSING COMPOSITIONS

(76) Inventors: Henry C. Gydesen, Oakdale, MN (US); Jon A. Kirschhoffer, White Bear Lake, MN (US); Marc Peuker, Schondorf (DE); John W. Dubbe, Starnberg (DE); Alexander Walter, Rurgen (DE)

Correspondence Address: 3M INNOVATIVE PROPERTIES COMPANY, PO BOX 33427, ST. PAUL, MN, 55133-3427, US

(21) Appl. No.: 12/598,374

(22) PCT Filed: Jan. 29, 2009
(86) PCT No.: PCT/US09/32327

§ 371 Date: Oct. 30, 2009

Related U.S. Application Data
(60) Provisional application No. 61/024,297, filed on Jan. 29, 2008.

(51) Int. Cl. A61C 19/00

(52) U.S. Cl. 433/49

(57) ABSTRACT

The present invention includes a device that includes a receptacle integrated with a mounting portion. The mounting portion is generally sized to fit, for example, over a portion of the user's body, providing convenient access to material in the receptacle during the application of the material to a surface. In some embodiments, a flexible connection connects the mounting portion and the receptacle. In other embodiments, the device includes at least two flexible mounting portions and, optionally, a fastener system.

### CROSS-REFERENCE TO RELATED APPLICATIONS

This application claims the benefit of U.S. Provisional Patent Application No. 61/024,297, filed on Jan. 29, 2008.

### BACKGROUND

Dental professionals often use liquid, gelatinous, or paste materials when providing dental care. Such materials include, for example, dental varnish, polishes, fillings, medications, and prophylactic remedies. It is desirable to have convenient access to such materials while administering dental care to a patient. Several devices have been developed that provide convenient access by putting the material directly in the hand of the dentist rather than placing the materials on a nearby tray which would require constant turning and shifting.

Certain devices, while in use, are pressed firmly against the user's finger, which can lead to discomfort. Moreover, such devices possess sharp edges that can damage examination gloves.

Other devices provide a dental care material in a disposable cup that can be snap fit into a reusable, secondary device that may be placed on the user's finger. The secondary device is not intended to be disposable and, therefore, must be sterilized between uses.

### SUMMARY

The present invention relates to a device that includes a receptacle that is integrated with a mounting portion.

In a first aspect, the device includes a receptacle and a mounting portion. The receptacle includes a top surface and a well that is formed in the top surface of the receptacle. The well also includes a bottom surface. At least one flexible connection connects the top surface of the receptacle and the mounting portion.

In some embodiments, the device summarized immediately above constitutes a receptacle portion of a larger device that further includes an applicator tray connected to the receptacle portion. The applicator portion is connected to the receptacle and includes a well that is formed to contain at least a portion of an applicator.

In certain embodiments of the first aspect of the invention, the device may further include a cover film adhered to at least a portion of the top surface of the receptacle and/or, if present, adhered to at least a portion of the applicator tray. In some embodiments, the device may further include an adhesive component adhered to the bottom surface of the well; such an adhesive component may optionally include a release liner. In some embodiments, the mounting portion of the device can include at least a partial ring that defines an aperture. In some embodiments, the mounting portion may define an ovoid aperture. In some embodiments, the edge of the mounting portion that defines the aperture may be rounded. In some embodiments, the mounting portion can include one or more notches. In some embodiments, the device can include at least two flexible connections connecting the receptacle and the mounting portion. In some embodiments, the device may be formed from a thermoplastic material, a metal foil material, or a combination thereof. In some embodiments, the device can include a plurality of wells, a plurality of mounting portions, or a plurality of both. In embodiments that include a plurality of wells, two or more wells may be connectable via a passage area that is selectively openable. Additionally, features summarized above with respect to some embodiments may be combined with one or more features summarized above with respect to other embodiments.

In a second aspect, the device includes a receptacle, at least two flexible mounting portions, and a fastener system disposed on at least one flexible mounting portion. The receptacle includes a top surface and a well that is formed in the top surface of the receptacle. The well further includes a bottom surface. Each flexible mounting portion possesses a distal end.

In some embodiments, the device of the second aspect of the invention may constitute a receptacle portion of a larger device that further includes an applicator tray connected to the receptacle portion. The applicator portion is connected to the receptacle and includes a well that is formed to contain at least a portion of an applicator.

In certain embodiments of the second aspect of the invention, the device may further include a cover film adhered to at least a portion of the top surface of the receptacle and/or, if present, adhered to at least a portion of the applicator tray. In some embodiments, the device may further include an adhesive component adhered to the bottom surface of the well; such an adhesive component may optionally include a release liner. In some embodiments, the device may be formed from a thermoplastic material, a metal foil material, or a combination thereof. In some embodiments, the flexible mounting portions are shapable. In some embodiments, the device can include a plurality of wells, a plurality of mounting portions, or a plurality of both. Additionally, features summarized above with respect to some embodiments may be combined with one or more features summarized above with respect to other embodiments.

In a third aspect, the invention includes kits. The kits include a device according to either the first aspect or second aspect of the invention summarized above, an applicator, and a dental care material.

### BRIEF DESCRIPTION OF THE DRAWING

FIG. 1A is a top perspective view of a device according to the present invention.

FIG. 1B is a bottom perspective view of a device according to the present invention.

FIG. 1C is a top perspective view of a device according to the present invention.

FIG. 1D is a top perspective view of an alternative embodiment of a device according to the present invention.

FIG. 2 is a top perspective view of an alternative embodiment of a device according to the present invention.

FIG. 3 is a top perspective view of an alternative embodiment of a device according to the present invention.

FIG. 4A is a top perspective view of an alternative embodiment of a device according to the present invention.

FIG. 4B is a side view of an alternative embodiment of a device according to the present invention.

FIG. 5A is a top perspective view of an alternative embodiment of a device according to the present invention.

FIG. 5B is a side view of an alternative embodiment of a device according to the present invention.

FIG. 6A is a top perspective view of an alternative embodiment of a device according to the present invention.

FIG. 6B is a top perspective view of an alternative embodiment of a device according to the present invention.

FIG. 6C is a top perspective view of an alternative embodiment of a device according to the present invention.

FIG. 6D is a top perspective view of an alternative embodiment of a device according to the present invention.

FIG. 7 is a top perspective view of an alternative embodiment of a device according to the present invention.

FIG. 8 is a top perspective view of an alternative embodiment of a device according to the present invention.

FIG. 9 is a top perspective view of an alternative embodiment of a device according to the present invention.

FIG. 10 is a top perspective view of an alternative embodiment of a device according to the present invention.

FIG. 11 is a top perspective view of an alternative embodiment of a device according to the present invention.

FIG. 12 is a top perspective view of an alternative embodiment of a device according to the present invention.

FIG. 13 is a bottom perspective view of an alternative embodiment of a device according to the present invention.

FIG. 14 is a top perspective view of an alternative embodiment of a device according to the present invention.

### DETAILED DESCRIPTION OF ILLUSTRATIVE EMBODIMENTS

The present invention includes a device that includes a receptacle integrated with a mounting portion. The mounting portion is generally sized to fit, for example, over a portion of the user's body, providing convenient access to material in the receptacle while the material is, for example, being applied to a surface. The device may be easily opened, readily manipulated into shape for use, and/or disposable. The device may be particularly suited for use during the application of dental care materials to a patient, although the device is not limited to such uses. Thus, while portions of the following description are set forth in terms of using the device in connection with applying and/or dispensing dental care materials to a patient, the features of the device are equally applicable to a device employed in connection with other uses within and beyond the dental and/or, more generally, health care-related arts. Accordingly, particular uses of any embodiment of the device and materials that may be stored in, contained in a well of, and/or dispensed from any embodiment of the device set forth in the description below should not be construed as limiting.

The terms “comprises” and variations thereof do not have a limiting meaning where these terms appear in the description and claims.

As used herein, “a,” “an,” “the,” “at least one,” and “one or more” are used interchangeably. Thus, for example, a receptacle that comprises a well can be interpreted to mean that the receptacle includes “one or more” wells.

The term “and/or” means one or all of the listed elements or a combination of any two or more of the listed elements.

Also herein, the recitations of numerical ranges by endpoints include all numbers subsumed within that range (e.g., 1 to 5 includes 1, 1.5, 2, 2.75, 3, 3.80, 4, 5, etc.).

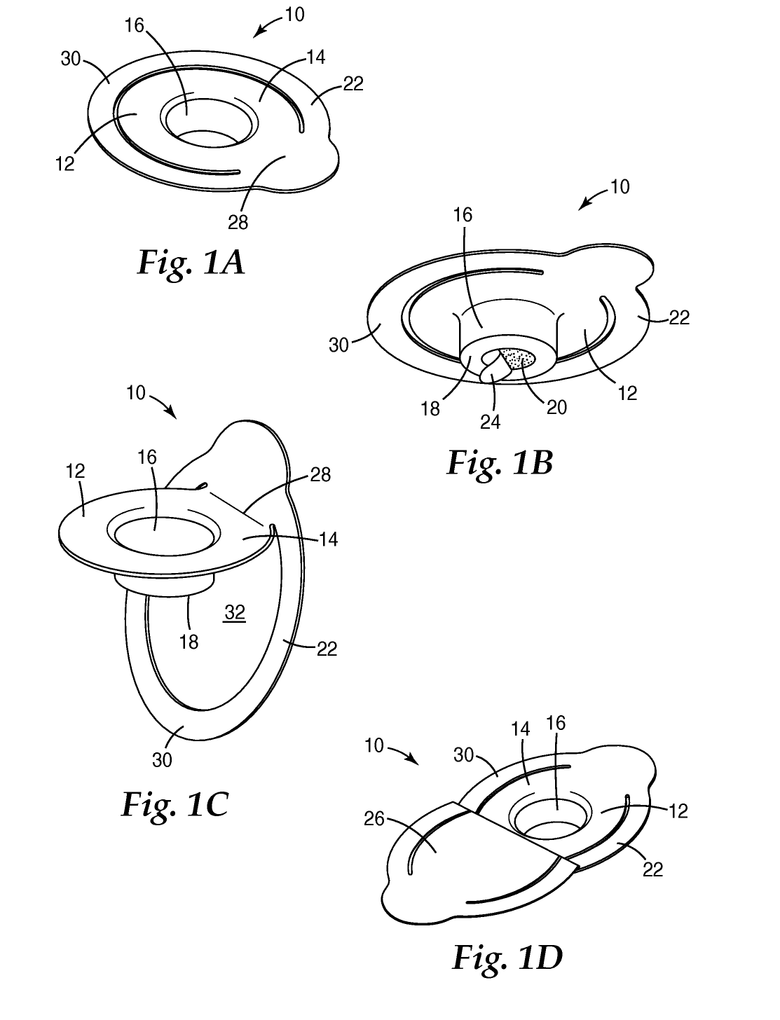

Generally, the device (10), shown in FIG. 1A, includes a receptacle (12) for holding a material such as, for example, a dental care material. The material may include a liquid, a gel, a paste, a suspension, a solid, a semisolid, an emulsion, etc. Exemplary materials include, for example, dental varnishes, polishes, dental filling materials, medications, and prophylactic treatment materials. In certain embodiments, described in more detail below, the material may be stored in the receptacle (12). The device (10) also includes a mounting portion (22) that is generally constructed to fit, or may be reformed to fit, over and/or around a portion of the user's body. This permits the user to place the device (10) over and/or around a portion of the user's body, thereby providing the user with convenient access to the receptacle (12) and the material therein, without requiring the user to hold the device (10). Thus, use of the device (10) may free the hands and/or fingers of the user for any dexterous activity that is required and/or desired for the application during which the device (10) is being used.

The device (10), generally, may be formed from any suitable material. In embodiments in which one or more materials (e.g., dental care materials) are to be stored in the device (10), the device (10) should be constructed from materials that are compatible with any material to be stored in the device (10). As used herein, a material from which the device (10) is formed is compatible with a material stored in the device (10) if it does not substantially degrade or compromise the effective use of material being stored in the device (10) over typical storage times. Suitable materials from which the device (10) may be formed include, for example, thermoplastic, thermosetting, and foil materials. Suitable materials for the device (10) include, for example, aluminum, polypropylene (PP), polyethylene (PE), polytetrafluoroethylene (PTFE), polyethylene terephthalate (PET), polyacrylamide (PA), polybutylene terephthalate (PBT), polyvinyl chloride (PVC), ethylene vinyl acetate (EVA), polyvinyl fluoride (PFV), and combinations thereof. Suitable foil materials include, for example, aluminum, tin, gold, silver, iron, and combinations thereof. Suitable materials further include, for example, foils that include an SiOₓ-containing layer. Moreover, the device (10) may include multiple layers of these materials (and/or other materials). For example, the device (10) may include a top layer of polyethylene, an intermediate layer of aluminum film and a bottom layer of polyethylene terephthalate.

The device may be formed using any method suitable for forming the materials described immediately above. Such methods are routine and known to those of ordinary skill in the art. Foil materials may be formed by, for example, rolling, embossing, stamping, etc. Polymeric materials may be formed by, for example, injection molding, thermoforming, vacuum forming (commonly known as vacuforming), etc. Also, combinations of suitable methods may be used, if desired.

In some cases, the device (10) may be a single integrated unit formed from similar—in some cases even identical—material throughout the entire device (10). In other embodiments, one portion of the device (10) may include different materials than one or more other portions of the device (10).

The receptacle (12) generally includes a top surface (14) into which a well (16) is formed. In use, the well (16) can hold, for example, dental care material. The well (16) also may be fashioned for storing dental care material prior to use. The well (16) may be of any suitable size or shape. Typically, the well (16) should have a size and depth adequate to establish a well capacity sufficient to hold a typical application of dental care material. For example, the well (16) may be of a size and shape to provide a well capacity of, for example, at least 0.25 milliliters (mL) to no more than 5.0 mL, although in many embodiments, the well (16) may provide a capacity outside of this range. In some embodiments, the well (16) may be of a size and shape to provide a well capacity of, for example, at least 0.25 mL, at least 0.5 mL, at least 1 mL, at least 2 mL, at least 5 mL, at least 10 mL, or greater. The well may have a capacity of, for example, no greater than 25 mL, no greater than 10 mL, no greater than 5 mL, no greater than 2 mL, no greater than 1 mL, or no greater than 0.5 mL. Also, devices intended for other applications, within or beyond the dental and/or health care-related arts, may include a capacity of, for example, at least 0.25 mL, at least 0.5 mL, at least 1 mL, at least 2 mL, at least 5 mL, at least 10 mL, or greater. The well may have a capacity of, for example, no greater than 25 mL, no greater than 10 mL, no greater than 5 mL, no greater than 2 mL, no greater than 1 mL, or no greater than 0.5 mL. Also, regardless of the particular application, the well (16) may be round, ovoid, rectangular, square or any other suitable shape.

The well (16) includes a bottom surface (18) that, in typical use, rests against a portion of the user's body such as, for example, a finger, a hand (particularly, but not exclusively, the back of the hand), a wrist, or an arm. As used herein, the term “finger” refers to any digit of the hand and, therefore, can include the thumb. Also as used herein, the terms “rests against” and “adhere to” a portion of the users body is not intended to mean, and should not be construed to require, direct contact between the bottom surface of the well and the user's body. The bottom surface of the well may rest against or adhere to a covering (e.g., a glove, gown, drape, or sleeve, etc.) that covers at least a portion of the user's body.

In some embodiments, shown in FIG. 1B, the bottom surface (18) can include an adhesive component (20) that can be used to adhere the bottom surface (18) of the well (16) to a portion of the user's body. The adhesive component (20) can, therefore, provide additional stability and/or security by limiting the likelihood and/or extent to which the well (16) can shift during use. The adhesive component (20) includes an adhesive layer that includes, for example, a pressure sensitive adhesive. The adhesive component (20) may include a release liner (24). A release liner (24) may be releasably adhered to the adhesive. When present, the release liner (24) may include a release coating. Suitable release coatings include, for example, siloxane- and acrylic-based compounds, and water-insoluble hydrophobic urethane (carbamate) copolymer of polyvinyl alcohol and octadecyl isocyanate.

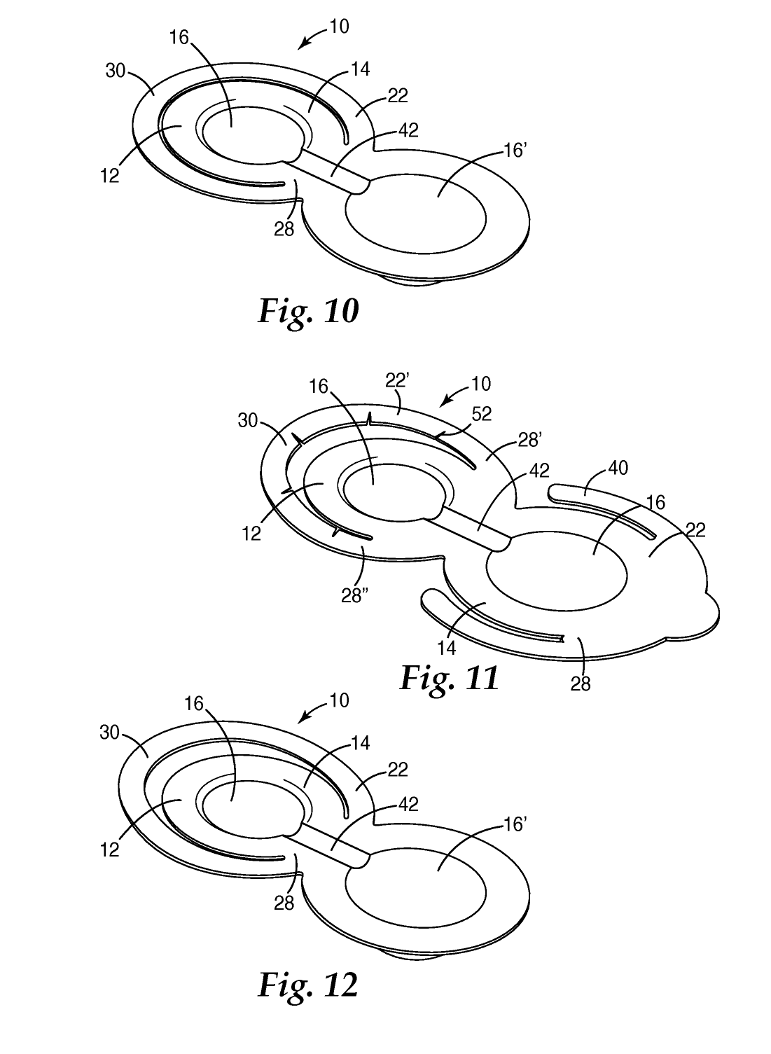

In some embodiments, the well (16) may further include a cover film (26) adhered to at least a portion of the top surface (14) of the receptacle (12), as shown in FIG. 1D. The cover film (26) may serve to maintain the sterility of the well (16) prior to use. In some cases, the device (10) may be stored with the well (16) empty. In these embodiments, the cover film (26) is removed prior to use and material (e.g., dental care material) may be added to the well (16). In other embodiments, material (e.g., dental care material) may be introduced to the well (16) prior to adhering the cover film (26) to at least a portion of the top surface (14) of the receptacle (12). In such embodiments, the material may be ready for use upon removal of the cover film (26) or as described in detail below in connection with the description of the embodiment of the device (10) depicted in, for example, FIG. 10. Use of the cover film (26) in this way allows, for example, material to be stored and dispensed safely and in a manner protected from contamination.

The cover film (26) may be made of any suitable material. In embodiments, in which, for example, material (e.g., dental care material) is stored in the well (16) and covered with a cover film (26), the cover film (26) should be compatible with the stored material—i.e., the cover film (26) material should not substantially degrade or compromise the effective use of the stored material over typical storage times. Suitable materials for the cover film (26) include, for example, aluminum, polypropylene, polyethylene, polyethylene terephthalate, and combinations thereof.

The cover film (26) and/or the top surface (14) of the receptacle (12) may include one or more features that permit the cover film (26) to be conveniently removed. For example, the cover film (26) may include a tab that overhangs and/or is not adhered to any portion of the top surface (14) of the receptacle (12). The cover film (26) tab may be grasped for convenient removal of the cover film (26). In other embodiments, the top surface (14) of the receptacle (12) may include a frangible section that may be broken to provide a tab that is readily grasped for removing the cover film (26).

In some embodiments, the receptacle can include a plurality of wells. Such embodiments may be useful, for example, for providing convenient access to a plurality of dental care materials that are to be simultaneous or sequentially administered to a patient. Alternatively, a plurality of wells may be useful for providing convenient access to a volume of, for example, dental care material that is greater than the capacity of a single well. In this way, various volumes of material can be provided without having to manufacture different sized wells. A plurality of wells also can permit storage of, for example, a dental care material in one well, which remains sealed during storage to reduce the likelihood and/or extent to which the dental care material is contaminated or otherwise compromised during storage. For use, the dental care material may be transferred to another well and, optionally, mixed with another material. Transferring the dental care material from the first well to a second well may include, for example, removing a cover film (26). Alternatively, dental care material may be transferred from one well to another via a selectively openable passage (42), describe in more detail below in connection with FIG. 10. The size, shape, presence of an adhesive component, presence of a cover film, and whether material is added to the well prior to adhering a cover film, if present, may be determined independently for each well.

The mounting portion (22) of the device (10) is generally constructed to fit, or may be reformed to fit, over and/or around a portion of the user's body. In certain embodiments, the device (10) may include a plurality of mounting portions (22) so that the device (10) can fit, for example, over a plurality of the user's fingers. In other configurations, a plurality of mounting portions (22) may be aligned so that more than one mounting portion (22) can fit over and/or around the same portion of the user's body. For example, two mounting portions may be aligned so that both mounting portions (22) can fit over and/or around a user's finger. The mounting portion (22) may assume various forms and, when a plurality of mounting portions (22) is present, the device (10) may include a plurality of mounting portion forms in any combination.

FIG. 1C shows an embodiment in which the device (10) includes a mounting portion (22) and a flexible connection (28) that connects the receptacle (12) to the mounting portion (22). The mounting portion (22) forms at least a partial ring (30) that defines an aperture (32). The at least partial ring (30) may be generally circular—and therefore define a generally circular aperture—although use of the term “ring” should not be construed to necessarily imply any particular shape. For example, in some embodiments, the at least partial ring (30) may be ovoid (see, e.g., FIG. 12) and, therefore, define an ovoid aperture. As used herein, the term ovoid generally refers to any curved shape resembling an elongated circle such as for example, an ellipse or an egg. Generally, the aperture (32) is shaped and of a size suitable to fit over and/or around a portion of the user's body such as, for example, a finger, hand, wrist, or arm. Thus, the particular shape of the at least partial ring (30) and the aperture (32) may be influenced, at least in part, by considerations of, for example, user comfort, manufacturing parameters, and ease of use.

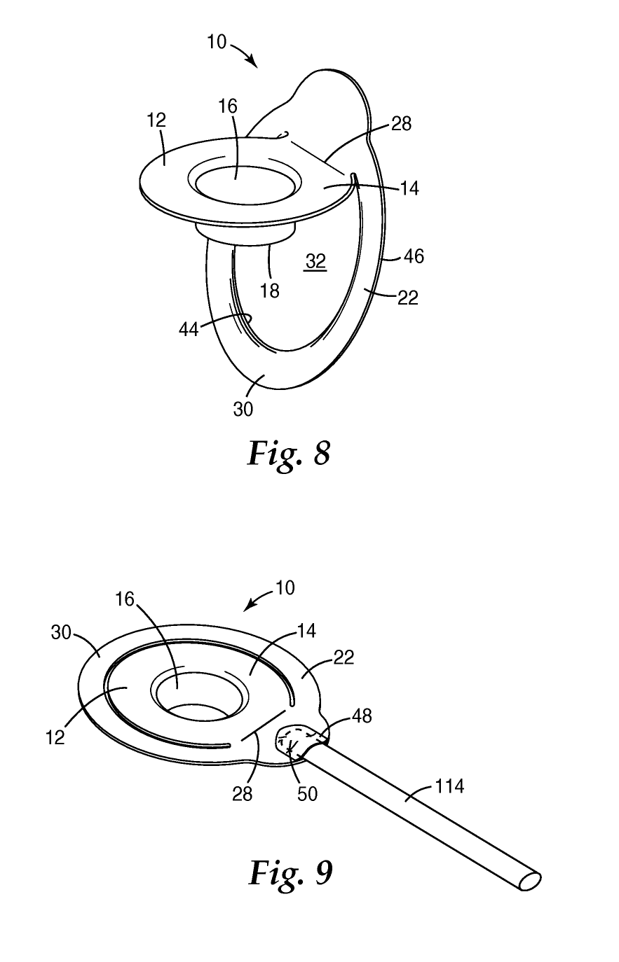

In some embodiment, as shown in FIG. 8, the mounting portion (22) can include an aperture edge (44) that is rounded. In some cases, the entire mounting portion (22) may be rounded, but in other embodiments, the external edge (46) of the mounting portion need not be rounded.

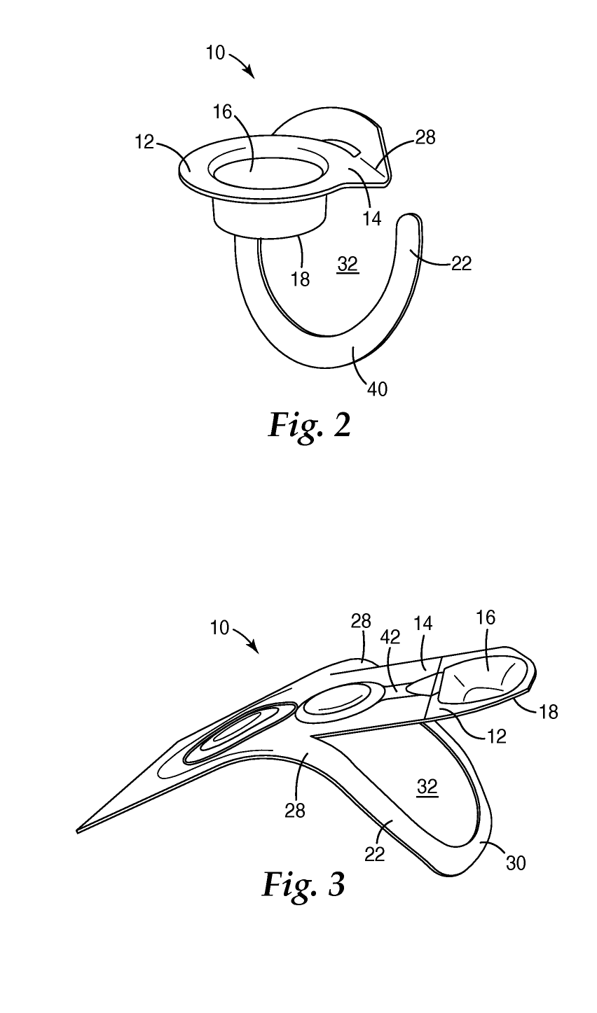

The mounting portion (22) may include a full ring (30), as shown in FIG. 1C, that completely encircles a portion of the user's body. In other embodiments, shown, for example, in FIG. 2 and FIG. 11, the mounting portion (22) may include a partial ring (40). Unless otherwise specifically specified, the term “at least partial ring” includes full ring structures as shown in FIG. 1C as well as partial ring structures as shown in FIG. 2. A partial ring (40) may provide more versatile fit over a wider array of portions of the user's body and/or a wider variety of dimensions of the portions of the user's body. Thus, a single device (10) may be used by persons having, for example, small fingers as well as by those having larger fingers. A partial ring (40) may include any portion of a ring to provide an adequate amount of structure to secure the well (16) during use. Thus, in certain embodiments in which the device (10) includes an adhesive component (20) on the bottom surface (18) of a well (16), the partial ring (40) may include a smaller portion of a ring than embodiments in which no adhesive component is used. The preferred extent of a partial ring (40) may be influenced at least in part by, for example, presence of an adhesive component, user comfort, manufacturing parameters, and ease of use.

In embodiments that include an at least partial ring (30), the device (10) may further includes a flexible connection (28) connecting the receptacle (12) and the mounting portion (22), as shown in, for example, FIG. 1C and FIG. 2. As used herein, “flexible” means that the connection (28) is bendable but does not break with typical use. In some embodiments, the flexible connection (28) may be a living hinge. As used herein, a living hinge is a thin, flexible region of bendable material (e.g., plastic or metal foil) that joins two less flexible regions together, and bends along the thinned line of the hinge to permit repositioning of the less flexible parts with respect to one another. The flexible connection (28) may possess spring memory. As used herein, spring memory refers to a characteristic of certain materials to be deformable, but tend to return to their original position following deformation.

Typically, the at least partial ring (30) is generally co-planar with the top surface (14) of the receptacle (12) during storage. The flexible connection (28) permits repositioning of the mounting portion (22) with respect to the receptacle (12) so that the mounting portion (22) fits over and/or around a portion of the user's body and the receptacle (12) can rest on top of the a portion of the user's body. By bending the flexible connection (28), the mounting portion (22) may be repositioned to position at any suitable angle with respect to the receptacle (12) such as, for example, a position that is generally perpendicular to the top surface (14) of receptacle (12), although the mounting portion (22) may be repositioned at other angles if desired by the user. However, the flexible connection (28) need not necessarily precisely maintain its repositioned conformation. For example, in embodiments in which the flexible connection possesses spring memory (28), the flexible connection (28) may tend to return to its original position after being repositioned. The tendency to return to its original position may provide sufficient pressure against a part of the user's body to provide stability of the device (10) during use. Considerations such as, for example, sizing, stability, spring memory, and comfort may influence, at least in part, the particular angle at which the mounting portion (22) is repositioned with respect to the receptacle (12).

In some embodiments, the device (10) may include one flexible connection (28) between the receptacle (12) and a mounting portion (22), as shown in, for example, FIG. 1C and FIG. 2. In other embodiments, the device (10) can include at least two flexible connection (28) sites between the receptacle (12) and the mounting portion (22), as shown in, for example, FIG. 3.

In some embodiments, as shown in FIG. 9, the receptacle (12) can include an applicator pocket (48) designed to contain at least a portion of an applicator (114). The applicator (114) may be secured in the applicator pocket (48) during storage by a cover film (50). For use, the cover film (50) may be broken or removed, liberating the applicator (114).

In some embodiments, the device (10) can include a plurality of wells (16) and (16′), as shown in, for example, FIG. 10. Such a device may include a single mounting portion (22), as shown in FIG. 10, or may include a plurality of mounting portions (22) and (22′), as shown in FIG. 11. When the device includes a plurality of mounting portions (22) and (22′) as shown in FIG. 11, each mounting portion (22) may be connected (28) to the top surface (14) of the receptacle (12) and be configured (e.g., shape, size, and other features as described below) independently of the connection (28′) and configuration of other mounting portions (22′).

Referring to FIG. 10, two or more of a plurality of wells (16) may be connectable via a selectively openable passage (42) (also shown in FIG. 3). That is, two wells (16) and (16′) may be separated by a breakable seal within the selectively openable passage (42). During use, material stored in one well (16′) may be transferred to another well (16) so that the material is available, for example, for applying or administering to a patient. In other uses, transferring the material to the second well (16) may permit the material to be prepared (e.g., mixed with another material) for administering or applying to a patient. Transferring the material from one well (16′) to another well (16) may be accomplished by applying pressure on the first well (16′), which, in turn, applies pressure to the breakable seal in the selectively openable passage (42). When enough pressure is applied, the breakable seal breaks, the selectively openable passage (42) opens, wells (16) and (16′) become connected, and the material may be transferred from one well (16′) to another well (16). Suitable selectively openable passages in combination with a plurality of wells are described in, for example, U.S. Pat. No. 6,105,761.

FIG. 12 illustrates an embodiment of the device (10) in which the mounting portion (22) is ovoid and, therefore, extends beyond the well (16) that, in this instance, is more circular than the mounting portion (22).

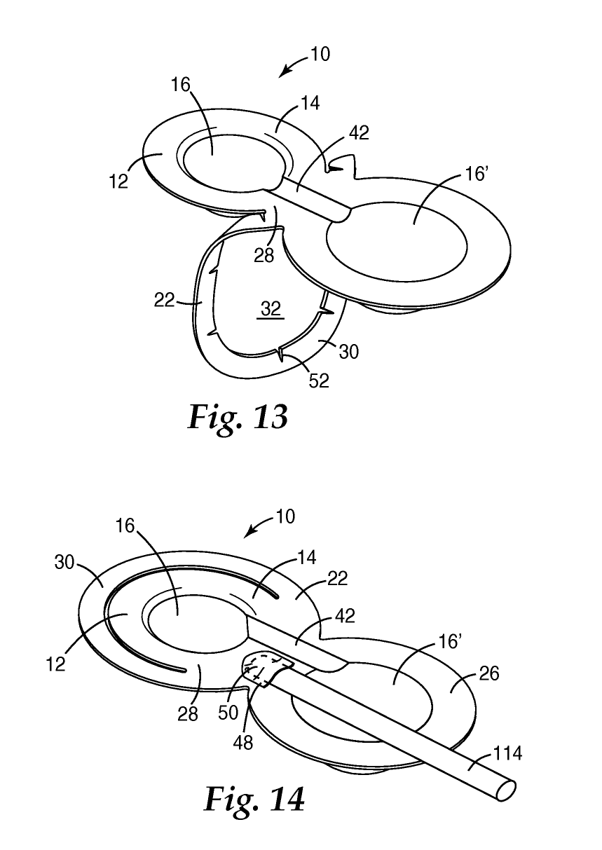

FIG. 13 illustrates an embodiment of the device (10) in which the mounting portion (22) includes a plurality of notches (52) along the aperture edge (44) of the mounting portion (22). The notches can permit the mounting portion (22) to flex somewhat when the user's body part (e.g., a finger) passes through the aperture (32). The notched aperture edge (44) can provide additional stability of the mounting portion on the finger, a more comfortable surface in contact with the finger, and/or provide an adjustable fit for different users. For example, the notches (52) can permit a relatively thicker finger to fit through the aperture (44) by flexing the mounting portion (22), effectively increasing the useful diameter of the aperture (44). Conversely, a relatively narrower finger can fit through the aperture (44) while flexing the mounting portion (22) to a lesser degree without compromising stability and/or comfort.

FIG. 11 illustrates an embodiment in which the device (10) includes two wells (16) and (16′) and two mounting portions (22) and (22′). Wells (16) and (16′) are connectable via a selectively openable passage (42). Thus, material may be stored in one well and, in use, transferred to the other well. As shown, either well (16) or well (16′) may be designated to be the well in which material is stored and the complementary well may be designated as the well into which the material is transferred for use. The mounting portions (22) and (22′) are aligned so that both may fit over and/or around a single finger. Mounting portion (22) is connected to the top surface (14) of the receptacle (12) by a single flexible connection (28), while mounting portion (22′) is connected to the top portion (14) of the receptacle (12) by two flexible connections (28′) and (28″). Mounting portion (22) possesses a somewhat different shape and size than mounting portion (22′). Also, mounting portion (22′) possesses notches (52) while mounting portion (22) does not. Thus, combinations of mounting portion (22) designs may be incorporated into a single device (10). Moreover, any desired mounting portion (22) design may be used in connection with any well (16) independent of whether a particular well (16) contains stored material or is a well into which the material may be transferred for use.

FIG. 14 illustrates an embodiment in which the device (10) includes a plurality of wells (16) and (16′) connectable via a selectively openable passage (42). One well (16), like mounting portion (22), is ovoid while well (16′) is more circular. As shown, well (16′) is covered by a cover film (26). The device (10) also includes an applicator pocket (48). In use, material stored in well (16′) may be transferred to well (16) by applying finger pressure on the bottom of well (16′) and on the portion of cover film (26) covering well (16′). This pressure can break a breakable seal in the selectively openable passage (42) allowing material stored in well (16′) to be transferred to well (16). The applicator (114) may be removed from the applicator pocket (48) prior to or after the material is transferred from well (16′) to well (16). The transferred material is available in well (16) to be administered or applied to a patient using the applicator (114). The material is also available for mixing with one or more additional materials before being administered or applied to a patient.

Features of the various embodiments described above may be combined with one or more features of other embodiments as appropriate. One such combination embodiment is shown, for example, in FIG. 11.

Also, in embodiments that include a plurality of wells (16) and fewer mounting portions (22) than wells (e.g., two wells (16) and one mounting portion (22)), each mounting portion may be designed to be in close proximity to any well or, alternatively, located substantially equidistant from each of two wells. Thus, in embodiments such as that depicted in FIG. 10, the mounting portion may be connected to the top surface (14) through a flexible connection (28) located between the wells (16) and (16′) as shown in FIG. 10. Alternatively, however, the flexible connection (28) may be located so that it is in connection with the top surface (14) in proximity to only one well (e.g., analogous to the position of the flexible connection (28) in FIG. 11), which may be either well. Finally, prior to use, a mounting portion (22) designed as an at least partial ring (30) may surround either a well in which material is stored or a well to which the material is transferred during use.

In some embodiments, the mounting portion (22) includes at least two flexible mounting portions (34) in which each flexible mounting portion (34) includes a distal end (36). In such embodiments, the distal end (36) of at least one flexible mounting portion (34) includes a fastener system (38). The fastener system (38) may be used to fasten the distal ends (36) of the flexible mounting portions (34), thereby securing the device (10) around a portion of the user's body.

The fastener system (38) may include any suitable system that permits securing the device (10) to a portion of the user's body. Suitable fastener systems (38) include, for example, ties, slits, a tab and slot, adhesive, snap, button and button hole, hook and loop fasteners, and the like. In certain embodiments, the distal end (36) of only one flexible mounting portion (34) may require a fastener system (38) component (e.g., an adhesive). In other embodiments, the distal end (36) of a first flexible mounting portion (34) can include a first fastener system (38) component (e.g., slits, hook and loop, etc.) and the distal end (36) of a second flexible mounting portion (34) can include a second fastener system (38) component. Also, some fastener systems (38) may be well-suited for permitting variable sizing of the fastened mounting portions (22) (e.g., adhesive, hook and loop, etc.). Such embodiments may be able to be conveniently and comfortably used by wider variety of individuals possessing diverse dimensions of the portion of the user's body over and/or around which the device (10) should fit. In some embodiments, the fastener system (38) merely includes forming the flexible mounting portions (34) of a material that is shapable. As used herein, term “shapable” refers to a material that may be, for example, bent, flexed, or twisted to form a desired shape and, once shaped, will substantially hold its new shape until reshaped or for a period of time sufficient for typical use (e.g., at least three, ten, 30, 60 minutes).

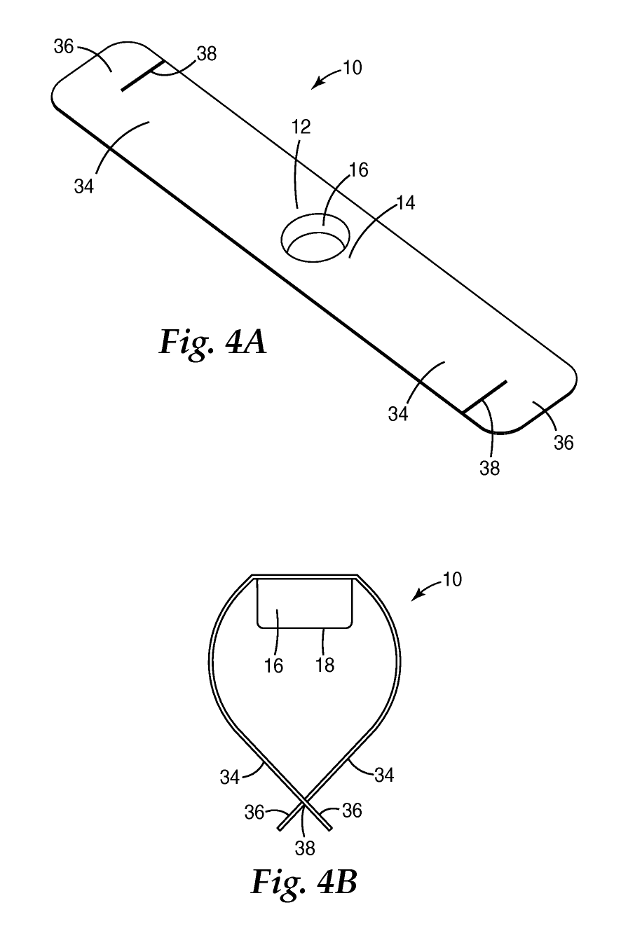

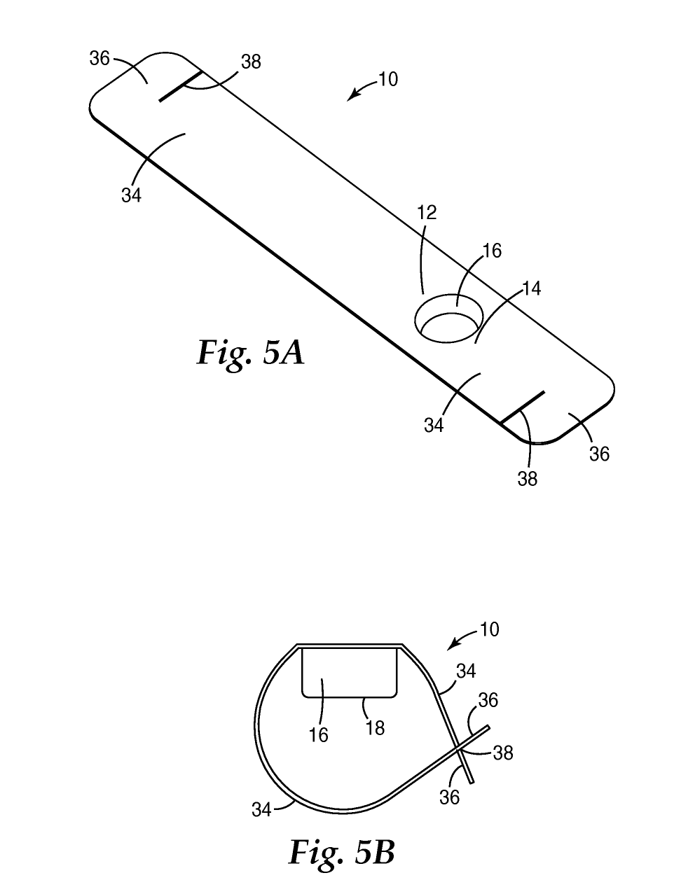

In certain embodiments, the device (10) may be designed to so that the receptacle (12) is preferably positioned relative to each of the fastener system (38) component(s) used to fasten the device (10). For example, FIG. 4A shows a device (10) having a well (16) positioned generally equidistant from fastener system (38) components. When fastened, the fastener system (38) components will be positioned at or near the opposite side of the aperture (32) from the well (16), as shown in FIG. 4B. In other embodiments, as shown, for example, in FIG. 5A, the well (16) may be located at a position that is not generally equidistant from the fastener system components (38) so that, when fastened, the fastener system components (38) may be positioned as shown in FIG. 5B.

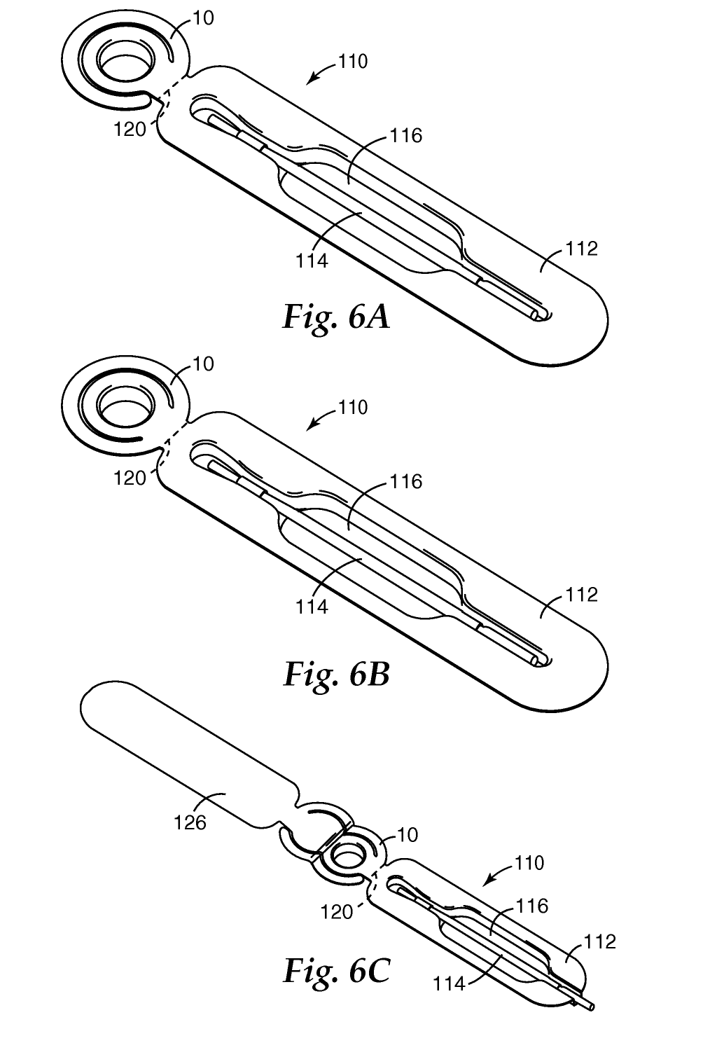

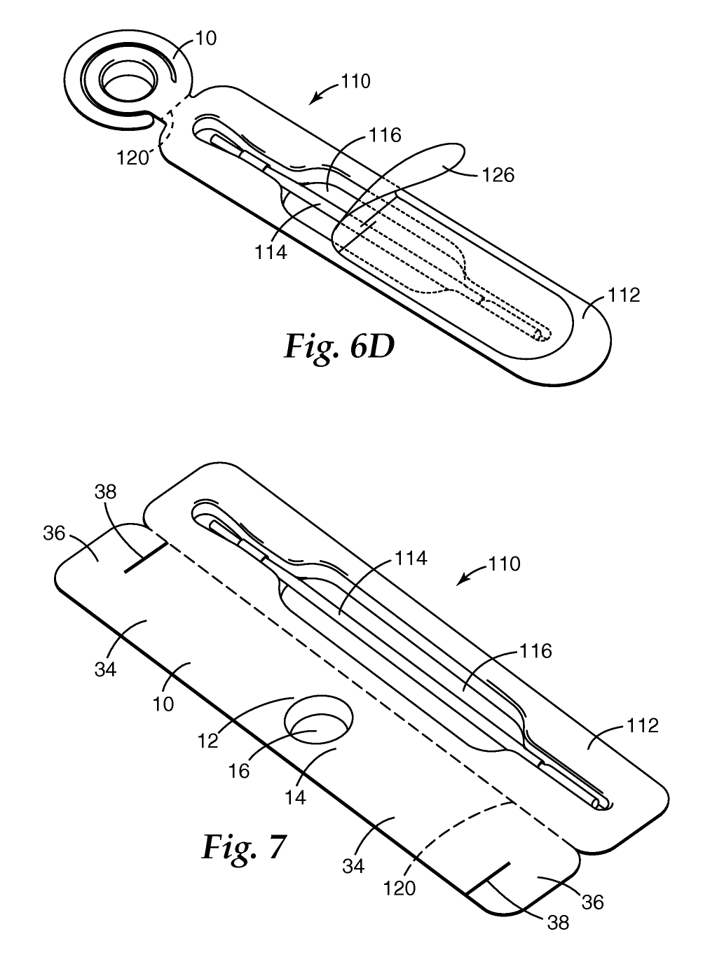

In some embodiments, shown in FIG. 6 and FIG. 7, for example, a device (110) may further include a tray (112) connected to the device (10) as already described. The tray (112) may be formed to include an applicator well (116) to hold at least a portion of an applicator (114) such as, for example, a brush, a cotton swab, a sponge swab, a spatula, a flock-type swab, a pad, etc. In some cases, the tray (112) may contain the entire applicator (114). In other embodiments, the tray (112) may be formed to contain only a portion of the applicator (114), with the remainder of the applicator (114) exposed. In such embodiments, the applicator (114) handle and the tray (112) may include features that assist retention of the applicator (114) in the tray (112) until intentionally removed for use. Such features are known in the art and may include, for example, a crimp/retainer system, a flange/recess system, and the like. In certain embodiments, the device (110) may include a cover (126), shown in FIG. 6C, may be used to form a seal at the end of the applicator well (116) to help prevent contamination from entering the open end of applicator well (116).

The applicator tray (112) and device (10) may be connected directly such as, for example, by a frangible connection (120). One such arrangement is shown in FIG. 6A in which a frangible connection (120) exists between one end of the applicator tray (112) and a portion of the at least partial ring (30) of the device (10). In use, the frangible connection (120) is broken, yielding the device (10) as described above and an applicator tray (112) that holds an applicator (114). In storage, the device (10) and the applicator tray (112) may be sealed with a cover film (126). In some cases, both the device (10) as described above and the applicator tray (112) may be sealed with a single cover film (126), as shown in FIG. 6C. In other cases, the receptacle (12) and well (16) of the device (10) may be sealed with one cover film (26) and the applicator tray well (116) may be sealed with a second cover film (126), as shown in FIG. 6D. FIG. 7 shows another embodiment in which the frangible connection (120) exists between one side of the applicator tray (112) and a side of the device (10) as described above.

Alternatively, the applicator tray (112) and the device (10) as described above may be connected indirectly such as, for example, each being adhered or affixed to a connecting material. The connecting material may include, for example, a cover film or a packaging component.

The present invention also includes kits that include the devices as described above, an applicator, and a dental care material. Thus, in certain embodiments, the kit contains a device, an applicator, and a dental care material. The device included in the kit can include a receptacle comprising a top surface and a well, wherein the well is formed in the top surface, and a mounting portion connected to the top surface of the receptacle by no more than one flexible connection; an applicator; and a dental care material. In some cases, the device can include additional mounting portions, each of which may be independently connected to the top surface of the receptacle by one or more flexible connections. In other embodiments, the device included in the kit can include a receptacle comprising a top surface and a plurality of wells, wherein each well is formed in the top surface of the receptacle and comprises a bottom surface; a mounting portion; and at least one flexible connection connecting the top surface of the receptacle to the mounting portion. In still other embodiments, the kit includes a device that includes a receptacle that includes a top surface and a well, wherein the well is formed in the top surface, and at least two flexible mounting portions, each flexible mounting portion having a distal end; an applicator; and a dental care material.

The complete disclosures of all patents, patent applications, and publications that are cited herein are hereby incorporated by reference as if individually incorporated. Various modifications and alterations of this invention will become apparent to those skilled in the art without departing from the scope and spirit of this invention, and it should be understood that this invention is not to be unduly limited to the illustrative embodiments set forth herein.

1. (canceled)

2. A device comprising:
a receptacle comprising a top surface and a plurality of wells, wherein each well is formed in the top surface of the receptacle and comprises a bottom surface;
a mounting portion; and
at least one flexible connection connecting the top surface of the receptacle to the mounting portion.

3. The device of claim 2 wherein the mounting portion comprises at least a partial ring that defines an aperture.

4-7. (canceled)

8. The device of claim 3 wherein the aperture is sized to fit over a portion of the user's body.

9. The device of claim 3 wherein the at least partial ring comprises an external edge and an aperture edge, and at least a portion of the aperture edge is rounded.

10. The device of claim 3 wherein the aperture includes an ovoid aperture.

11-16. (canceled)

17. The device of claim 2 further comprising an applicator pocket.

18. The device of claim 2 wherein the receptacle comprises a plurality of wells, and wherein at least one well contains a dental care material and is connectable to a second well via a passage area that is selectively openable.

19. A device comprising:
a receptacle portion comprising the device of claim 2; and
an applicator tray connected to the receptacle, wherein the applicator tray comprises a well that is formed to contain at least a portion of an applicator.

20. The device of claim 19 comprising a frangible connection connecting the receptacle portion and the applicator tray.

21-26. (canceled)

27. The device of claim 19 wherein the receptacle comprises a plurality of wells.

28. The device of claim 27 wherein at least one well contains a dental care material and is connectable to a second well via a passage area that is selectively openable.

29. The device of claim 19 wherein the mounting portion comprises at least a partial ring that defines an aperture.

30-33. (canceled)

34. A device comprising:
a receptacle comprising a top surface and a well, wherein the well is formed in the top surface of the receptacle and comprises a bottom surface;
at least two flexible mounting portions, each flexible mounting portion having a distal end; and
a fastener system disposed on at least one flexible mounting portion.

35. The device of claim 34 further comprising a cover film adhered to at least a portion of the top surface of the receptacle.

36. The device of claim 34 further comprising an adhesive component adhered to the bottom surface of the well.

37. (canceled)

38. The device of claim 34 wherein the fastener system comprises a plurality of components and a first component of the fastener system is disposed on the distal end of a first mounting portion and a second component of the fastener system is disposed on the distal end of a second mounting portion.

39. The device of claim 34 wherein the flexible mounting portions are shapable.

40. (canceled)

41. A device comprising:
the device of claim 34; and
an applicator tray connected to the receptacle, wherein the applicator tray comprises a well that is formed to contain at least a portion of an applicator.

42. The device of claim 41 comprising a frangible connection connecting the receptacle portion and the applicator tray.

43. The device of claim 41 further comprising a connecting material that connects the receptacle portion and the applicator tray, wherein the connecting material is adhered to at least a portion of the receptacle portion and at least a portion of the applicator tray.

44. The device of claim 41 further comprising a cover film adhered to at least a portion of the top surface of the receptacle.

45. The device of claim 41 further comprising a cover film adhered to at least a portion of the applicator tray.

46. The device of claim 41 further comprising an adhesive component adhered to the bottom surface of the well.

47-52. (canceled)

53. A kit comprising:
the device of claim 2;
an applicator; and
a dental care material.

54. A kit comprising:
the device of claim 34;
an applicator; and
a dental care material.
